(19) United States
(12) Patent Application Publication
(10) Pub. No.: US 2017/0017984 A1
(43) Pub. Date: Jan. 19, 2017

(54) NETWORK CONCESSIONAL SALES METHOD

(71) Applicant: Tsung-Yu Chen, Tainan City (TW)

(72) Inventor: Tsung-Yu Chen, Tainan City (TW)

(21) Appl. No.: 14/811,712

(22) Filed: Jul. 28, 2015

(30) Foreign Application Priority Data
Jul. 17, 2015 (TW) 104123285

(51) Int. Cl. G06Q 30/02

(52) U.S. Cl. CPC G06Q 30/0233

(57) ABSTRACT

In a network concessional sales method, a client logs in a network sales system. A service party accesses the network sales system to provide concessional sales conditions of each commodity. The network sales system permits each logged-in client to browse database information of the concessional sales conditions of each commodity. The client acts as a recommender by sending the information of the recommended commodity to recommended clients, permitting the recommended clients to know the information of the recommended commodity. The recommender or the recommended clients purchase of the recommended commodity through the network sales system. The network sales system automatically calculates a discounted price of the recommended commodity based on the concessional sales conditions and accumulated concessions based on the recommendation. After completion of the purchase of the recommended commodity, the network sales system automatically adds a total concession to an account of the recommender.

### BACKGROUND OF THE INVENTION

The present invention relates to a network concessional sales method and, more particularly, to a network concessional sales method using a network to provide concessions through multi-level recommendations.

The running methods of network sale channels become more versatile, because using networks as the marketing channels becomes more convenient. Since network marketing has reduced costs in physical shops and personnel, the proportion of network marketing income becomes higher, more products or services are provided in network marketing, the network marketing strategies become more flexible, and various new sale promotions emerge on the market from time to time. All of these are the trend of current network markets.

Tens of millions of products are being sold in famous channels, such as eBay that is famous in the United States of America, and PChome and Taobao that are famous in Asia, leading to big competition among these channels. In addition to the service quality provided by the software and hardware of each network seller, the following promotion methods are used to attract customers: (1) increasing the product creditability through endorsement by a famous people, and (2) promotion by providing discounts; and (3) providing cash discounts to members having loyalty points.

However, there are still problems in actual sale after years of use of these promotion methods: (1) Large product experience differences exist between the famous people endorsing the product and the purchasers, failing to attract the purchasers. Specifically, a purchaser cannot touch or use the product being sold on the network, particularly clothes, shoes, cosmetics, skin care products, and other personal articles (such as sports articles or tools). The consumers can only image the product by watching the photographs on the network marketing pages. After use, if the purchaser feels the purchased product is not suitable, returning of the product could be unacceptable after a period of time. Thus, the advertisements provides a lower or even poor promotion effect when the difference between the product experience of the purchasers and the product quality is great; and (2) Different measures, including discounts, concessions, loyalty points, and recommendation gifts, are formal equity that cannot provide better help in marketing: Discounts cannot reflect the difference between the sales volume and the costs and will become a burden to the seller if the sales volume is not good enough. When the sales volume is good, the measures, including discounts, concessions, loyalty points, and recommendation gifts, are fixed and, therefore, cannot further benefit the consumers. Thus, the consumers cannot receive substantial benefits from the formal equality type concessions and will not actively recommend the products. As a result, the sales volume cannot be further increased.

### BRIEF SUMMARY OF THE INVENTION

A network concessional sales method according to the present invention includes:

a login step: a client logs in a network sales system and discloses personal information of the client;

a concessional sales conditions provision step: a service party accesses the network sales system to provide concessional sales conditions of each commodity of the service party, the concession sale conditions includes upper and lower limits of a price of the commodity and includes concessions in terms of recommendation of each commodity and purchase of each commodity upon the recommendation;

a system setting step: the network sales system sets the login step and information related to the concessional sales conditions provision step and permits each logged-in client to browse database information of the concessional sales conditions of each commodity of the service party;

a recommendation step: the client acts as a recommender by selecting the recommended commodity through the network sales system and sending the information of the recommended commodity to computers or accounts of smart devices of recommended clients, permitting the recommended clients to know the information of the recommended commodity;

a system purchase step: the recommender or the recommended clients acknowledge and select purchase of the recommended commodity through the network sales system, the network sales system automatically calculates a discounted price of the recommended commodity based on the concessional sales conditions and accumulated concessions based on the recommendation; and

a concession feedback step: after completion of the purchase of the recommended commodity, the network sales system automatically calculates a total concession of the recommender based on the concessional sales conditions of the recommended commodity purchased by each recommended client and a level of recommendation of each recommended client and then adds the total concession to an account of the recommender.

The concessional sales conditions can include setting of the level of recommendation and a concession calculation formula for calculating the concessional price or the concession of each level.

The upper and lower limits of the price of each commodity can be set by the concession calculation formula. Each recommended client recommended by the recommender is set as a first-level recommended client after the purchase of the recommended commodity, and the purchase by each first-level recommended client gives the recommender a first feedback concession. Each recommended client recommended by the first-level recommended client is set as a second-level recommended client after purchase of the recommended commodity, and the purchase by each second-level recommended client gives the recommender a second feedback concession, and so on. The total concession is calculated accumulatively based on the first and second feedback concessions and optional feedback concessions from lower levels of recommendation.

Each recommended client in the recommendation step is permitted to conduct the login step and the recommendation step.

The present invention will become clearer in light of the following detailed description of illustrative embodiments of this invention described in connection with the drawings.

### DESCRIPTION OF THE DRAWINGS

FIG. 1 is a diagrammatic view illustrating an example of a network concessional sales method according to the present invention.

FIG. 2 is a diagrammatic view illustrating an example of a recommendation step according to the present invention.

FIG. 3 is a diagrammatic view illustrating an example of a concession feedback step according to the present invention.

### DETAILED DESCRIPTION OF THE INVENTION

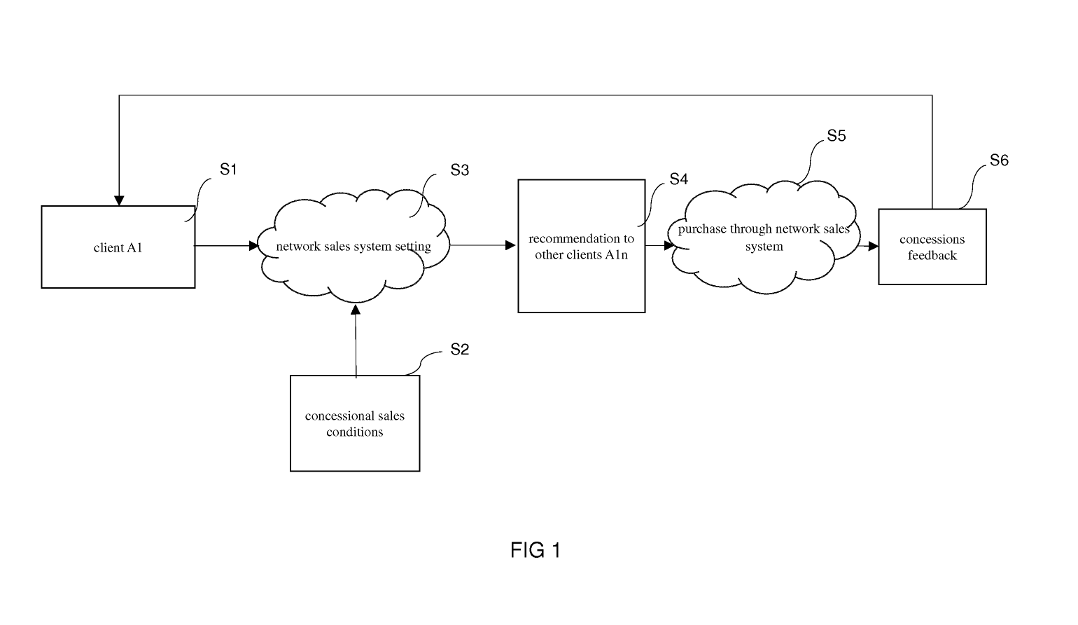

FIG. 1 is a diagrammatic view illustrating an example of a network concessional sales method according to the present invention. To provide a better advertisement effect of network marketing for increasing the commercial income, the network concessional sales method according to the present invention is more flexible and can attract the consumers to help promotions, providing a better network marketing mechanism.

The network concessional sales method according to the present invention includes a login step S1. Specifically, a client A1 logs in a network sales system and discloses personal information of the client A1.

The network concessional sales method further includes a concessional sales conditions provision step S2. Specifically, a service party accesses the network sales system to provide concessional sales conditions of each commodity of the service party. The concessional sales conditions includes upper and lower limits of a price of the commodity and includes concessions in terms of recommendation of each commodity and purchase of each commodity upon the recommendation. The concessional sales conditions can include setting of the level of recommendation and a concession calculation formula for calculating the concessional price or the concession of each level. For example, the concession calculation formula sets the upper and lower limits of the price of the commodity to be 500 and 800 dollars, respectively. Each recommended client recommended by a recommender is set as a first-level recommended client (A11, A12, A13 . . . ) after the purchase of the recommended commodity, and the purchase by each first-level recommended client (A11, A12, A13 . . . ) gives the recommender a first feedback concession (such as 10 dollars). Each recommended client recommended by the first-level recommended client is set as a second-level recommended client (A111, A112, A121, A122, A131 . . . A1nn) after purchase of the recommended commodity, and the purchase by each second-level recommended client (A111, A112, A121, A122, A131 . . . A1nn) gives the recommender a second feedback concession (such as 3 dollars), and so on. The total concession is calculated accumulatively based on the first and second feedback concessions and optional feedback concessions from other lower levels of recommendation. For example, if 10 first-level recommended clients (A11, A12, A13 . . . ) and 25 second-level recommended clients (A111, A112, A121, A122, A131 . . . A1nn) purchase the commodity, the total concession obtained by the recommender A1 will be 175 (10*10+25*3). However, the feedback concessions provided to the recommender are limited. The lowest price of the commodity purchased by the recommender cannot be lower than the lower limit (500 dollars in this example).

The network concessional sales method further includes a system setting step S3. Specifically, the network sales system sets the login step S1 and information related to the concessional sales conditions provision step S2. Furthermore, the network sales system permits each logged-in client (A1, A1, A1 . . . An) to browse database information of the concessional sales conditions (S2-1, S2-2, S2-3 . . . S2-n) of each commodity of the service party.

The network concessional sales method further includes a recommendation step S4. Specifically, when a recommender (e.g., client A1) is intended to recommend a commodity of the service party, the recommender A1 selects the recommended commodity through the network sales system and sends the information of the recommended commodity to computers or accounts of smart devices of recommended clients, permitting the recommended clients to know the information of the recommended commodity. Due to the intimacy and trust between the recommender and the recommended clients and since the recommender knows the need of the recommended clients, the possibility of acceptance of the recommended commodity is greatly increased. Furthermore, each recommended client is permitted to conduct the login step S1, the recommendation step S4, and a system purchase step S5 if the recommended client appreciates the commodity and is willing to purchase the commodity and/or recommending the commodity to the second-level recommended clients.

In the system purchase step S5, the recommender or the recommended clients acknowledge and select purchase of the recommended commodity through the network sales system, and the network sales system automatically calculates a discounted price of the recommended commodity based on the concessional sales conditions set forth in the concessional sales conditions provision step S2 and the accumulated concessions based on the recommendation in the recommendation step S4.

The network concessional sales method further includes a concession feedback step S6. Specifically, after completion of the purchase of the recommended commodity, the network sales system automatically calculates the total concession of the recommender based on the concessional sales conditions (step S2) of the recommended commodity purchased by each recommended client and the level of recommendation of each recommended client (step S4) and then adds the total concession to an account of the recommender.

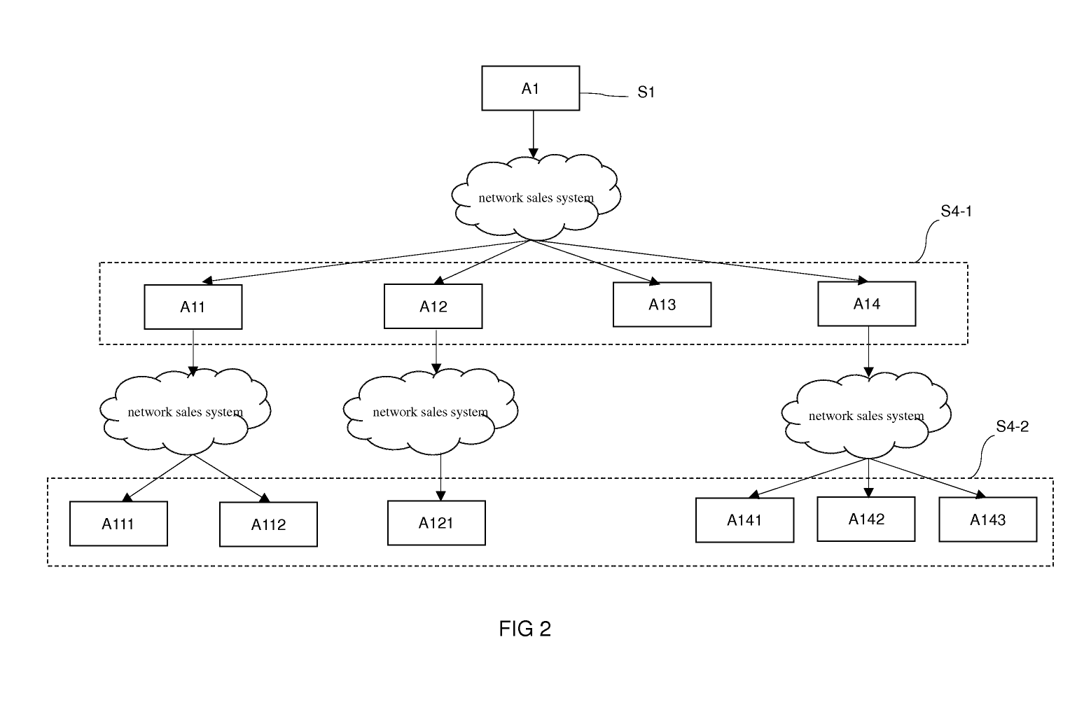

FIG. 2 is a diagrammatic view illustrating an example of the recommendation step according to the present invention. With regard to calculation of the concessions of the client A1 while the network sales system operates, the client A1 that has completed the login step S1 can execute the first-level recommendation step S4-1 through the network sales system to recommend a commodity to the first-level recommended client A11, A12, A13, A14. Then, each first-level recommended client A11, A12, A13, A14 logs in the network sales system to execute the second-level recommendation step S4-2 to recommend the commodity to the second-level recommended client A111, A112, A121, A141, A142, A143. Thus, the advantages of the commodity are propagated (branch promotion) to the recommended clients which are family and friends of the recommenders. The concessional sales conditions set forth in the concessional sales conditions provision step S2 attracts each level of clients to pass on the recommendation. Each client can expect a more favorable discounted price and can trust the recommender and the use experience of the recommender on the commodity, providing a new and highly reliable consuming pattern.

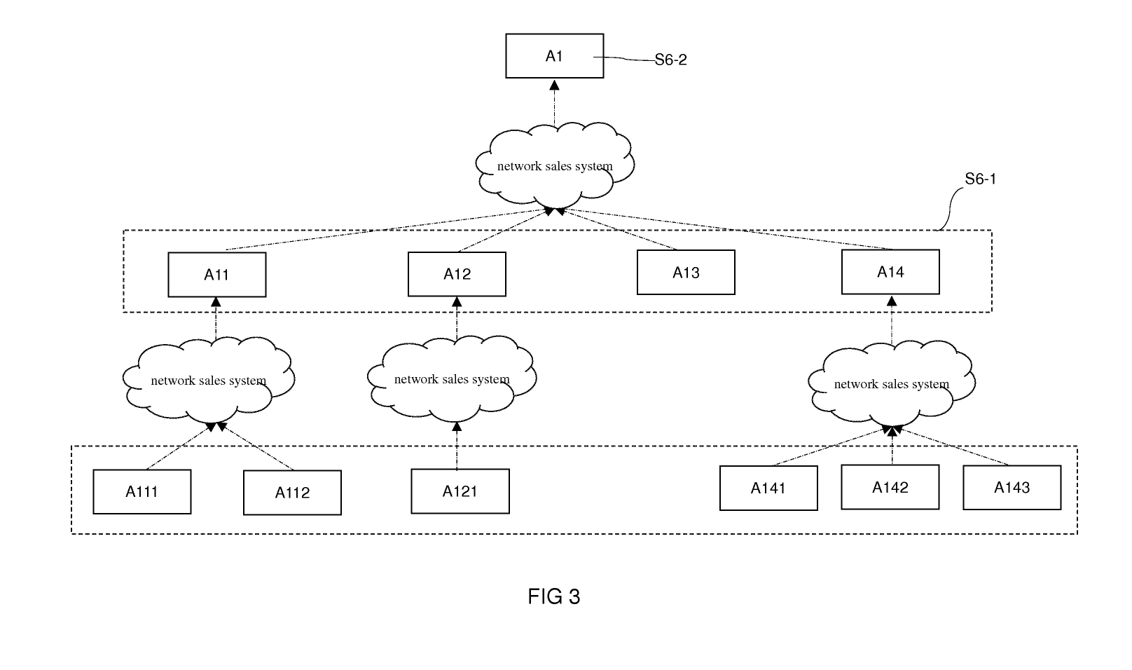

FIG. 3 is a diagrammatic view illustrating an example of the concession feedback step according to the present invention. After completion of the purchase of the commodity by each recommended client, the network sales system executes the concession feedback step S6-1, S6-2 to feed back the concessions to the account of the recommender based on the levels of recommendation. This marketing method can greatly increase the sales volume of the commodity. Furthermore, the concessional sales conditions provision step S2 provides costs control for the service party. Given the upper and lower limits of the price of the commodity, the relationship between the sales volume and the costs can be controlled more precisely. The profit proportion can be controlled when the sales volume is not high. On the other hand, when the sales volume reaches the peak, each client can be offered with a more favorable price while maintaining the profit, achieving a win-win situation.

Although specific embodiments have been illustrated and described, numerous modifications and variations are still possible without departing from the scope of the invention. The scope of the invention is limited by the accompanying claims.

1. A network concessional sales method comprising:
a login step: a client logs in a network sales system and discloses personal information of the client;
a concessional sales conditions provision step: a service party accesses the network sales system to provide concessional sales conditions of each commodity of the service party, the concessional sales conditions includes upper and lower limits of a price of the commodity and includes concessions in terms of recommendation of each commodity and purchase of each commodity upon the recommendation;
a system setting step: the network sales system sets the login step and information related to the concessional sales conditions provision step and permits each logged-in client to browse database information of the concessional sales conditions of each commodity of the service party;
a recommendation step: the client acts as a recommender by selecting the recommended commodity through the network sales system and sending the information of the recommended commodity to computers or accounts of smart devices of recommended clients, permitting the recommended clients to know the information of the recommended commodity;
a system purchase step: the recommender or the recommended clients acknowledge and select purchase of the recommended commodity through the network sales system, the network sales system automatically calculates a discounted price of the recommended commodity based on the concessional sales conditions and accumulated concessions based on the recommendation; and
a concession feedback step: after completion of the purchase of the recommended commodity, the network sales system automatically calculates a total concession of the recommender based on the concessional sales conditions of the recommended commodity purchased by each recommended client and a level of recommendation of each recommended client and then adds the total concession to an account of the recommender.

2. The network concessional sales method as claimed in claim 1, wherein the concessional sales conditions include setting of the level of recommendation and a concession calculation formula for calculating the concessional price or the concession of each level.

3. The network concessional sales method as claimed in claim 2, wherein the upper and lower limits of the price of each commodity are set by the concession calculation formula, each recommended client recommended by the recommender is set as a first-level recommended client after the purchase of the recommended commodity, the purchase by each first-level recommended client gives the recommender a first feedback concession, each recommended client recommended by the first-level recommended client is set as a second-level recommended client after purchase of the recommended commodity, the purchase by each second-level recommended client gives the recommender a second feedback concession, and so on, and the total concession is calculated accumulatively based on the first and second feedback concessions and optional feedback concessions from lower levels of recommendation.

4. The network concessional sales method as claimed in claim 1, wherein each recommended client in the recommendation step is permitted to conduct the login step and the recommendation step.
